(19) United States
(12) Patent Application Publication
(10) Pub. No.: US 2013/0320828 A1
(43) Pub. Date: Dec. 5, 2013

(54) COOKING DEVICE, CLOSURE MECHANISM AND DOOR OPERATING ELEMENT FOR A COOKING DEVICE, AND KIT

(71) Applicants: Martin Nitzsche, Peissenberg (DE); Markus Ernst, Murnau (DE)

(72) Inventors: Martin Nitzsche, Peissenberg (DE); Markus Ernst, Murnau (DE)

(73) Assignee: Convotherm Elecktrogerate GmbH, Eglfing (DE)

(21) Appl. No.: 13/993,215

(22) PCT Filed: Dec. 16, 2011
(86) PCT No.: PCT/IB11/03081

§ 371 Date: Aug. 21, 2013

(30) Foreign Application Priority Data
Dec. 16, 2010 (DE) 10 2010 054 820.0

(51) Int. Cl. A47J 27/04

(52) U.S. Cl. CPC A47J 27/04
USPC 312/237

(57) ABSTRACT

Cooking device, in particular commercial combi-steamer with a housing and arranged on it a door to a cooking chamber, the cooking device having a closure mechanism for the door and an door operating element for the closure mechanism with the closure mechanism being suitable to keep the door closed against the housing wherein the door operating element and the closure mechanism are mechanically decoupled.

### BACKGROUND

1. Field of the Disclosure

The invention relates to a cooking device, a closure mechanism and a door operating element for a cooking device, as well as to a kit.

2. Discussion of the Background Art

According to the state of art in mechanically operated door locks for cooking devices the operating mechanism i.e. the handle is placed at the door and the opposite part of the door lock is placed at the housing of the device. The operating mechanism and the opposite part are arranged in a congruent way. To ensure sealing the of the door of the cooking chamber, there is only limited scope for the position of the door lock. This means in term that the position of the door handle is only slightly variable. A different position of the door handle can be realized by an often complicated and therefore costly diversion. For large doors often two and more closure mechanisms are needed to achieve a successful sealing. In this case two more door handles are provided and need to be operated. It is also possible to use only one door handle and several locking mechanisms if a diversion is integrated. Usually the space where the door handle can be placed is limited with regard to its position as well as its optical and mechanical design.

To avoid illegal or unwanted opening of the door for example during cleaning, an additional locking mechanism is required. This additional locking mechanism can either be mechanically or electronically operated.

If it is electronically operated it ensures the locking of the door independent of an information at a mechanical door handle. Therefore, such an electronic door lock typically does not have any door operating element. There is no possibility to lock or unlock the door lock mechanism by means of a door operating element. On the contrary, the door lock assembly is electronically controlled according to predefined conditions to hinder unwanted opening.

It is an object of the invention to improve the known devices.

### SUMMARY

According to a first aspect of the invention this object is solved by means of a cooking device, in particular a commercial combi-steamer, with a housing and arranged in it a door to an oven whereby the cooking device has a closure mechanism for the door and an door operating element for the closure mechanism with the closure mechanism being suitable to keep the door closed against the housing whereby the door operating element and the closure mechanism are mechanically decoupled.

The “closure mechanism” encompasses the mechanical means to close the door by holding it tight, to open the door by releasing the hold, or both.

The “door operating element” is the element meant for the user personnel to operate, e.g., a handle, a mechanical button, a sensor, a switch or any type of mechanical operating element, or e.g. an electronic sensor, button, switch or perhaps a voice control microphone or a gesture recognizing camera. A door operating element can be located at the door, but does not necessarily have to be there. It can also e.g. be located on the housing. However, it could also be located at a remote place not even on the cooking device but somewhere in its vicinity e.g. at a rack or at the wall. In this case it is helpful to provide a grip on the door to be able to hold the door manually without the handle for opening and closing the door being placed on the door.

“Mechanically decoupled” means that the e.g. door handle, which is operated for opening and/or closing of the door to the cooking chamber has no mechanical actuation connection to the actual closure mechanism. The connection to the actual closure mechanism for unlocking or locking the door to the cooking chamber can be e.g., electronic or electrical.

“Combi-steamer” means a canteen kitchen appliance for cooking with hot air, steam or superheated steam. The cooking chamber is the place inside the oven in which food is cooked.

Advantageously, the door operating element and the closure mechanism are in a signal connection via a signal transmitter and a signal receiver, in particular with a duplex signal connection. The signal connection via the signal transmitter and the signal receiver can use simplex communication which means that the signal transmitter only transmits and the signal receiver just listens and does not transmit a signal itself However, also a duplex communication system is possible where the two connected devices can communicate with one another in both directions. In particular the door handle with a signal transmitter may transfer a signal to the door closing mechanism for opening and closing with a signal receiver.

The signal connection can comprise a radio means, a power line means and/or an optical transmission means. While a radio means uses the transmission of signals by modulation of electromagnetic waves with frequencies below those of visible light, optical transmission means use electromagnetic waves with frequencies of visible light or beyond. Also a power line means can be used, that puts transmitter and receiver in an electric connection.

It is further advantageous when an electronic control system is provided for the closure mechanism, which is designed to be able to translate a signal from the door operating element to the control means for opening the closure mechanism.

In particular the door handle can include a switch e.g. a reed contact which upon actuation sends a signal via a cable to the electronic control system. In term the electronic control system controls a lifting solenoid, a motor and so forth which opens the closing mechanism.

The door handle can also include a transmitter that sends a radio signal to the electronic control system when the door handle is operated. Thereupon the electronic control system controls a lifting solenoid, a motor and so forth which opens the locking mechanism.

It is possible to define conditions under which the electronic control system is translating a signal for opening and or for closing.

In the case of a particularly suitable embodiment the control is designed not to translate a signal from the door operating element to a control for the opening of the closure mechanism in the presence of a defined condition for keeping the door shut. The unlocking of the door is initiated by a signal from the control. It is possible without additional effort to realize a door locking mechanism, in which despite an opening signal from the door operating element the opening mechanism is not activated.

Like this it is configurable, when the door opens and minimum cooking times can be safeguarded. If there are several cooking and regeneration processes ongoing, it is possible to control the time at which the door can be opened for a new loading.

In quick service restaurants (QSR) a user can be prevented from opening the door in an ongoing cooking process. It can be assured that cooking times are observed even by untrained users, by keeping the door shut until a certain time is reached. In a QSR environment it is notably helpful to determine the time at which a new product can be loaded.

Furthermore user safety is increased. In critical situations such as during cleaning the door can be kept shut. An additional locking mechanism for the cooking chamber is no longer needed, since the ground state is a locked door.

In another particularly suitable embodiment the controller is configured to perform an opening signal for the closure mechanism in the presence of a defined condition for opening the door, regardless of any opening signal of the door operating element.

This too allows to assure that predefined cooking times are observed independent of the fact that a user tries to open the door. In this case it is secured that maximum cooking times are observed.

Advantageously, the controller is configured to perform another activation, in particular of an extraction hood and/or of a lighting and/or of an acoustic signal unit and/or of a fan. Like that it is possible to realize automatic cooking programs that include an on-latch position with an eventual start of an extraction hood. An on-latch position means a position in which the door is not yet open but steam can already escape. Like that new extraction hoods are possible that are constructed for a specialized use in an on-latch position. After being automatically put into an on-latch position it is possible to release the door to a fully open position after a certain time.

It is further advantageous if the controller is configured to verify an authorization of a user for the door operating element. Such a personalization can be obtained by using radio frequency identification (RFID). Also other means e.g. a camera or a biometrical measure can be employed to decide who can open the door to the cooking chamber and at what times.

A partially open position for the door can be defined, in which starting from a close state the door is stopped in a waiting position on its way to a fully open position. This position can be an on-latch position in which the door is not yet open but steam can already escape. It is possible to pro-vide for an automatic closing of the door from the on-ledged position if a cleaning process or a cooking program is started.

Advantageously, a drive is provided for a part of the closure mechanism, in particular for a housing-side part of the closure mechanism. Using a drive is one possibility of activating the closure mechanism without making manual intervention. If the drive is housing sided, it does not add to the door and it is easier to provide the necessary power supply. The closure mechanism can especially comprise a pin, a spring clip, a magnet and/or a locking pin. In particular the cooking chamber door is secured by a pin that is held in position by means of a coil spring. The pin can be displaced on a short term basis when slamming the door as it is typically used in closing mechanisms for front doors. It is also possible to use a safety lock with two stages as typically used in locking mechanisms for car doors. It is also possible to use a solenoid that withdraws the pin to unlock the door like the mechanisms used in a central locking system in cars.

It is possible that the closure mechanism has a plurality of discrete closing positions that can be activated jointly with an opening control for the opening. Like that several locking mechanisms in several discrete closing positions can be activated by one controller. This is of particular ad-vantage if a large door is used to achieve a sufficient sealing of the door. For large devices with only one handle several closure mechanisms are activated and sealing improved.

The door operating element can comprise a mechanical handle, in particular a rotary handle. Also other mechanical panels are possible that react to turning, pushing or pulling. For example a button or sensor can be used. Also optical means can form the door handle. Furthermore it is possible to use contactless measures like RFID or a camera. Furthermore the handle for example in sheet form can be mounted on the door to the cooking chamber. Alternatively the handle can be recessed in the door to the cooking chamber. In this case a recessed grip can be reached via a grasping recess. The result is a plane and elegant appearance. It is not possible to hit the handle and the cooking device needs less space in a closed state.

All the handle variants have any degree of freedom of actuation. All types of operation, e.g. turning, spinning, pulling and so forth can be configured user defined also via software by using multiple contacts.

According to a particularly suitable embodiment the handle has a signal trainer for sending the opening signal on reaching of a displacement position defined for sending the opening signal.

Accordingly to the further particularly suitable embodiment a second door operating element is provided for delivering an opening signal, wherein in particular each door operating element is able to produce a sufficient signal for opening. This second switch can be operated in parallel and can be e.g. a foot switch.

It is particularly advantageous when the door operating element is mobile, in particular as a freely placeable transmitter at the door, at the housing or as a remote control means. Like that it is possible to variably position the door handle at the installation site at the customer and eventually feasible by the customer. Ultimately, the door handle can be fixed subsequently by suitable adhesive tape or several mounting points are provided such that the door handle can be changed in its position. If a non-stationary transmitter i.e. a remote control means is used it can be manually operated. Several forms of activation can also be combined. In the case of a remote control means, the remote control means does not have to be fixed on the cooking device or in its vicinity. It can be freely moved around with the user.

The door operating element can comprise a capacitive sensor. Preferably the door operating element comprises an electrical power source. This can be a battery in a battery box. For example a lithium battery can run for several years.

The energy supply of the door operating element can also be realized by energy harvested. In this case the energy can be created by moving the door, due to the temperature difference between door and environment, by vibration or actuation of the door handle and so forth or as a combination of those. The so harvested energy can be stored and used at a later point in time.

The door operating element and the closure mechanism at the cooking device can be arranged with an offset so that they fall apart on a projection on a plane of the door with the door closed. Like that it is possible to freely place the door operating element and the closure mechanism.

Advantageously a mechanical emergency door operating element is provided. In case the electrically operated door handle fails, it is possible to circumvent the system and mechanically open the cooking chamber in case of an emergency like a loss of power.

A second aspect of the invention relates to a closure mechanism in particular with a control and a drive and an door operating element for a cooking device.

A third aspect of the invention relates to an door operating element for a cooking device in the form of a swivel handle, wherein the door operating element comprises an electrical power source.

A fourth aspect of the invention relates to a method for operating a door closure mechanism for a cooking device, wherein the door closure mechanism is operated by a controller and the controller transmits a signal to the door closure mechanism to open the door.

In an embodiment in one step the controller checks the identity of a user. Depending on the outcome of this check the controller either transmits or does not transmit a signal to the door closure mechanism to open the door.

In another embodiment in one step the controller checks the status of a cooking program. Depending on the status of the cooking program, e.g. if particularly hot steam or smokes are within the cooking chamber or depending on certain predefined timing conditions the door remains closed. If none of these conditions is fulfilled the controller transmits a signal to the door closure mechanism to open the door.

In a further embodiment in one step the controller checks the status of a cleaning program. If the cleaning program is in a state where the door cannot be opened, the door remains closed. If no cleaning is ongoing or if the cleaning program is in a state where the door can be opened the controller transmits a signal to the door closure mechanism to open the door.

### BRIEF DESCRIPTION OF THE DRAWINGS

The invention will be described in more detail herein after with reference to an exemplary embodiment. In the drawing, the

FIG. 1 shows a schematic representation of a cooking device with a door handle located on the door of the cooking device with two closure mechanisms,

FIG. 2 shows a schematic representation of a cooking device with a sensor for activating the door placed on the housing and one closure mechanism,

FIG. 3 shows a schematic representation of a cooking device with a sensor placed on the housing and two closure mechanisms and

FIG. 4 shows a block diagram containing the logic for the control aspects.

### DETAILED DESCRIPTION OF THE PREFERRED EMBODIMENT

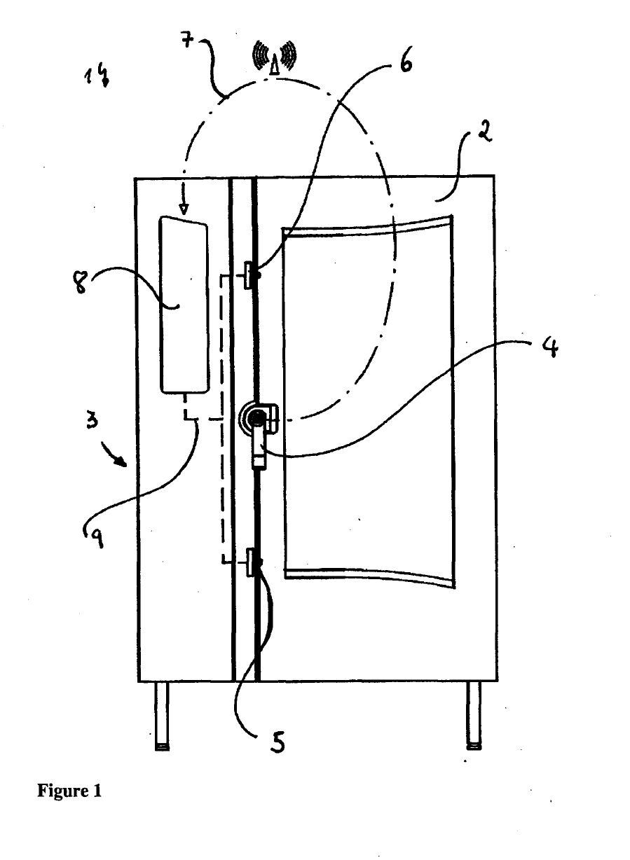

The cooking device 1 in FIG. 1 has a door 2 to a housing 3, the door being operated with a door handle 4. The door handle 4 interacts with two closure mechanisms 5, 6. In particular the door handle 4 sends a signal 7 to a control 8 that receives the signal and then translates the signal 7 and sends a signal 9 to the closure mechanisms 5, 6. That in turn leads to an opening or closing of the closure mechanisms 5, 6.

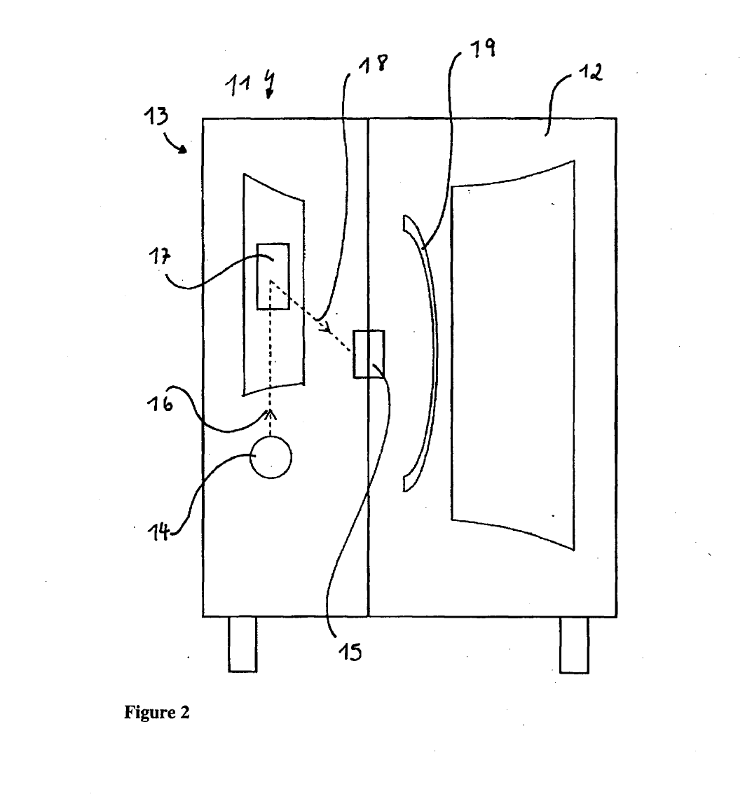

The cooking device 11 in FIG. 2 has a housing 13 with a door 12. The door is operated with a sensor 14 for activating the door e.g. a switch or a button or something similar to that. The sensor 14 is located on the housing 13. The sensor 14 interacts with a closure mechanism 15. In particular the sensor 14 sends a signal 16 to a control 17 that receives the signal and then translates the signal 16 and sends the signal 18 to the closure mechanism 15. Depending on the signal this leads to an opening or closing of the closure mechanism 15. To be able to grasp the door during opening and closing of the door a grip 19 is placed on the door. However, this grip 19 is in no connection with the closure mechanism 15.

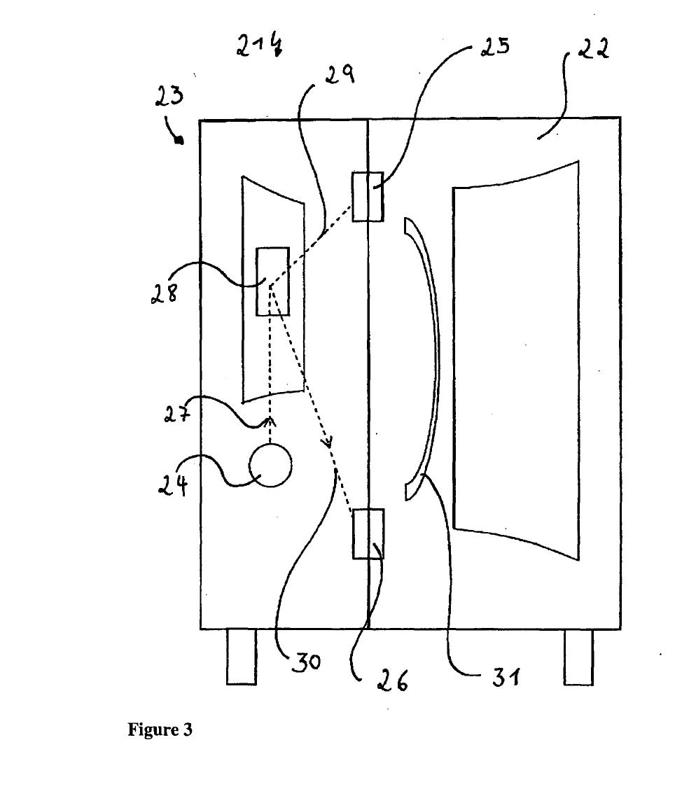

The cooking device 21 in FIG. 3 again comprises a housing 23 with a door 22. A sensor 24 is placed on the housing 23. The sensor 24 interacts with two closure mechanisms 25, 26. In particular the sensor 24 sends a signal 27 to a control 28 that receives the signal 27 and then translates this signal 27 in two signals 29, 30 to the closure mechanisms 25, 26. That in turn leads to an opening or closing of the closure mechanisms 25, 26. However, if the control determines, that no signal for opening is to be sent to the closure mechanisms 25, 26 no such a signal is sent. Again the door has a grip 31 for holding the door.

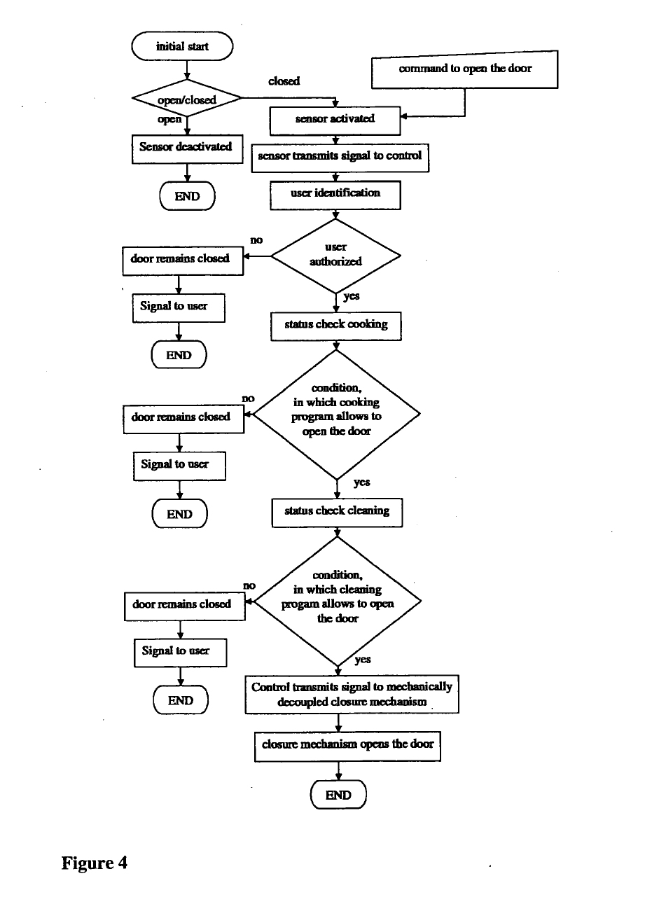

The controls 8, 16, 28 act according to the block diagram in FIG. 4. As a precondition for sensor activation it is checked whether the door is open or closed. If the door is open the sensor is deactivated. If the door is closed the sensor is activated. When the sensor is activated and receives a command to open the door it transmits the signal to the control. The control determines, whether the door can be opened or not by checking the identity of the user and/or the status of a cooking and/or a cleaning program. In a first step it compares the user identity with the list of authorized users. In a second step it compares the status of the cooking program with conditions in which the cooking program allows to open the door. If “yes” the status of a cleaning program is checked and compared with conditions in which the cleaning program allows to open the door. If “yes” the control transmits a signal to the mechanically decoupled closure mechanism and the closure mechanism opens the door. If either the user lacks authorization or one of the conditions of either the cooking or the cleaning program does not match with the status then “no” and the door remains closed. A signal is shown to the user, e.g. a warning message or a notice of lack of authorization displayed on a display.

What is claimed is:

1. Cooking device comprising a housing, a cooking chamber and a door disposed on said housing about said cooking chamber, said cooking device further comprising:
a closure mechanism which keeps the door closed against said housing while in a closed position and allows said door to open to provide access to said cooking chamber when in the open position;
a controller which communicates with said closure mechanism to be in the open or closed position; and
a door operating element in communication with said controller. wherein said door operating element communicates with said controller that a user wants said door to be in either said open position or closed position,
wherein the door operating element and the closure mechanism are mechanically decoupled from one another.

2. Cooking device according to claim 1, wherein the door operating element and the closure mechanism are in signal communication with said controller via their respective signal transmitters and signal receivers.

3. Cooking device according to claim 2, wherein the signal communication comprises at least one means of communications selected from the group consisting of: a radio transmission, a power line transmission and an optical transmission.

4. Cooking device according to claim 1, further comprising an electronic control system which transmits a signal from the door operating element to a controller for opening or closing the closure mechanism.

5. Cooking device according to claim 4, wherein the controller is configured not to transmit said signal to activate said closure mechanism when a defined condition for keeping the door shut is present.

6. Cooking device according to claim 4, wherein the controller is configured to transmit said signal to activate the closure mechanism when a defined condition for opening the door is present.

7. Cooking device according to claim 4, wherein the controller is further configured to perform at least one step selected from the group consisting of: activating an extraction hood, activating lighting, activating an acoustic signal, and activating a fan.

8. Cooking device according to claim 4, wherein the controller is configured to verify an authorization of said user for the door operating element.

9. Cooking device according to claim 1, wherein a partially open position for the door is defined, in which, starting from a closed state, the door is stopped in a waiting position on its way to a fully open position.

10. Cooking device according to claim 1, wherein the closure mechanism comprises a drive.

11. Cooking device according to claim 1, wherein the closure mechanism comprises at least one element selected from the group consisting of: a pin, a spring clip, a magnet and a locking pin.

12. Cooking device according to claim 1, wherein the closure mechanism comprises a plurality of discrete closing positions that can be activated jointly with an opening control for opening.

13. Cooking device according to claim 1, wherein the door operating element comprises a mechanical handle.

14. Cooking device according to claim 13, wherein the handle has a signal trigger for sending an opening signal to said controller upon reaching a predefined displacement position defined.

15. Cooking device according to claim 1, wherein the door operating element is a transmitter and/or sensor freely placeable at the door or at another place of the cooking device, or separate from the cooking device, or as a remote control unit.

16. Cooking device according to claim 1, further comprising a second door operating element which is capable of delivering another opening signal.

17. Cooking device according to claim 1, wherein the door operating element comprises a capacitive sensor.

18. Cooking device according to claim 1, wherein the door operating element comprises an electrical power source.

19. Cooking device according to claim 1, wherein the door operating element and the closure mechanism at the cooking device are arranged with an offset to one another under a projection on a plane of the door with the door closed.

20. Cooking device according to claim 1, further comprising a mechanical emergency door operating element is provided.

21. (canceled)

22. (canceled)

23. Kit comprising a closure mechanism for a cooking device, a door operating element for a cooking device, and a controller for receiving a door operating element signal from the door operating element and for transmitting a closure or opening signal to the closure mechanism.

24. Method to operate a door closure mechanism of a cooking device by a controller, said method comprising:
transmitting a first signal from a door operating element to said controller indicating that a user wants to open or close a door to said cooking device; and
transmitting a second signal from said controller to a signal to the door closing mechanism to open or close the door.

25. Method according to claim 24, further comprising: authorizing a user before transmitting said second signal from said controller to said closing mechanism.

26. Method according to claim 24, further comprising: checking the status of a cooking program.

27. Method according to claim 24, further comprising: checking the status of a cleaning program.
